(19) United States
(12) Patent Application Publication
(10) Pub. No.: US 2014/0175088 A1
(43) Pub. Date: Jun. 26, 2014

(54) COOKER AND METHOD FOR MANUFACTURING THE SAME

(71) Applicants: Jongwoog LEE, Changwon-si (KR); Baeyoung Kim, Changwon-si (KR)

(72) Inventors: Jongwoog LEE, Changwon-si (KR); Baeyoung Kim, Changwon-si (KR)

(21) Appl. No.: 14/087,079

(22) Filed: Nov. 22, 2013

(30) Foreign Application Priority Data
Dec. 24, 2012 (KR) 10-2012-0152253
Jan. 2, 2013 (KR) 10-2013-0000158

(51) Int. Cl. H05B 6/64; H05B 6/80

(52) U.S. Cl. CPC H05B 6/6402; H05B 6/6411; H05B 6/80
USPC 219/756; 219/762; 29/428

(57) ABSTRACT

A cooker and a method for manufacturing the same are provided. The cooker may include a cavity having a cooking chamber, an electrical chamber, in which a part to provide heat to the cooking chamber may be disposed, the electrical chamber being defined in one side of the cavity, and a door disposed on a side of the cavity to selectively open or close the cooking chamber. The cavity may include a bottom portion that defines a bottom surface of the cavity, a side portion that extends backward from each of both sides of the bottom portion, and a rear portion rounded to extend backward from the side portion.

### CROSS-REFERENCE TO RELATED APPLICATION(S)

The present application claims priority under 35 U.S.C. 119 and 35 U.S.C. 365 to Korean Patent Application No. 10-2012-0152253 filed in Korea on Dec. 24, 2012 and No. 10-2013-0000158 filed in Korea on Jan. 2, 2013, which are hereby incorporated by reference in their entirety.

### BACKGROUND

1. Field

A cooker and a method for manufacturing the same are disclosed herein.

2. Background

Cookers may include microwave ovens. In general, microwave ovens (MWOs) are devices for cooking food using frictional heat between molecules generated by disturbing a molecule arrangement in the food using high frequency as a heating source. The high frequency may be a frequency of about 2,400 MHz/s to about 2,500 MHz/s.

A MWO according to the related art will be described with reference to FIG. 8. The MWO according to the related art includes a front plate 1, on which a door (not shown) is openably disposed, a cavity 2 that defines a cooking chamber, and a rear plate 7 that defines a rear surface of the MWO.

The cavity 2 includes side plates 3, a bottom plate 4, and a top plate 5. The side plates 3, the bottom plate 4, and the top plate may be coupled to each other to define the cooking chamber within the cavity 2.

An electrical chamber is defined outside of the cavity 2. The rear plate 7 is disposed on or at a rear side of the electrical chamber. Electrical components that are difficult to mount within the cavity 2 may be installed on the rear plate 7. Also, one or more through holes 8 for air flow within the electrical chamber may be defined in the rear plate 7.

The MWO including the above-described components according to the related art may have following limitations.

First, as the cavity has a hexahedral shape, that is, one surface has a rectangular shape, to define the cooking chamber having the hexahedral shape, it may be difficult to clean corner portions at which the bottom surface, the side surfaces, and the rear surface meet each other within the cooking chamber.

Second, microwaves transferred into the cooking chamber may be concentratedly radiated into the corner portions. Thus, it may be difficult to uniformly heat food within the cooking chamber due to the cavity 2 having the angulated configuration according to the related art.

Third, in the process for manufacturing the cavity 2, when the bottom plate and the side plates are assembled, a gap may occur therebetween. Thus, when a welding process is performed on the gap, the welded portion may be easily exposed to the outside.

Fourth, a painting process is performed after the bottom plate and the side plates are welded, and paint may flow outside of the cavity through the gap. As a result, the welded or coupled portion, that is, a boundary of the coupled portion between the bottom plate and the side plate, may cause a flimsy outer appearance.

Therefore, a user's reliability and satisfaction with respect to the product may be deteriorated.

### BRIEF DESCRIPTION OF THE DRAWINGS

Embodiments will be described in detail with reference to the following drawings in which like reference numerals refer to like elements, and wherein:

FIG. 1 is an exploded perspective view of a cooker according to an embodiment;

FIG. 2 is a view illustrating internal components of a cavity of the cooker of FIG. 1;

FIGS. 3 and 4 are views illustrating a portion of the components of the cavity of the cooker of FIG. 1;

FIG. 5 is a view illustrating internal components of a cavity according to another embodiment;

FIG. 6 is a cross-sectional view taken along line VI-VI′ of FIG. 5;

FIG. 7 is a flowchart of a method for manufacturing a cooker according to an embodiment; and

FIG. 8 is a view of a related art cooker.

### DETAILED DESCRIPTION

Hereinafter, exemplary embodiments will be described with reference to the accompanying drawings. Embodiments may, however, be embodied in many different forms and should not be construed as being limited to the embodiments set forth herein; rather, alternate embodiments included in other retrogressive inventions or falling within the spirit and scope of the present disclosure will fully convey the concept to those skilled in the art.

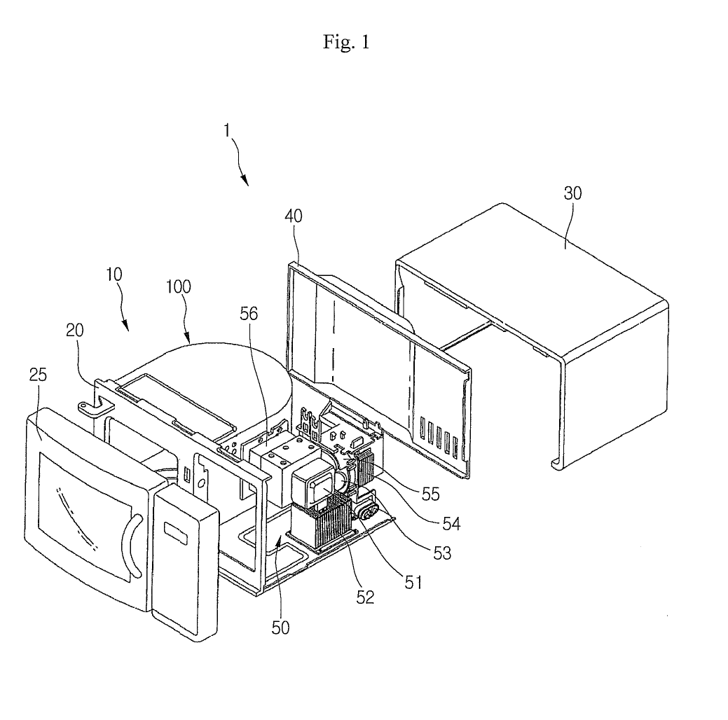

FIG. 1 is an exploded perspective view of a cooker according to an embodiment. Referring to FIG. 1, a cooker 1 according to this embodiment may include a main body 10 including a front plate 20, an outer case 30, and a rear plate 40, a cavity 100 having a cooking chamber, and an electrical chamber 50 in which various electrical components may be installed. The electrical chamber 50 may be defined in a space of or at a side of the cavity 100. A door 25 to selectively open or close the cooking chamber may be disposed on or at a front side of the front plate 20.

The outer case 30 may define both side surfaces and a top surface of the main body 10. The outer case 30 together with the front plate 20 and the rear plate 40 may protect the cavity 100 and the electrical chamber 50 from the outside.

A magnetron 51 to generate microwaves, a high-voltage transformer 52 to supply a high voltage to the magnetron 51, a blower fan 53 to cool various electrical components within the main body 10, and a fan motor 54 to drive the blower fan 53 may be installed in the electrical chamber 50. The fan motor 54 may be fixed to the rear plate 40, and a shroud 55 may be mounted around the blower fan 53 to guide an air flow.

A wave guide tube 56 to guide the microwaves may be disposed on or at an outer surface of the cavity 100. A front portion of the magnetron 51 may be mounted within the wave guide tube 56.

A rear portion of the cavity 100 may be rounded with a predetermined curvature. Hereinafter, components of the cavity 100 will be described with reference to the accompanying drawings.

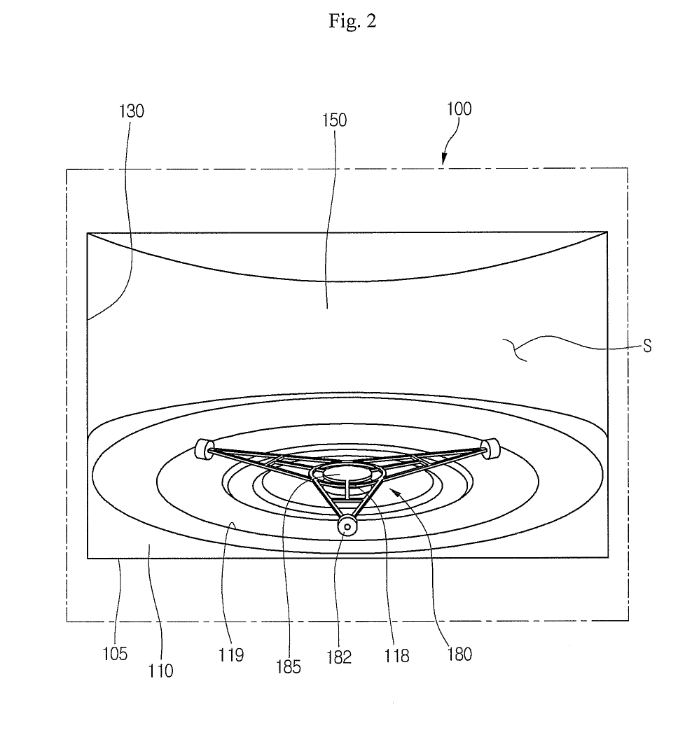

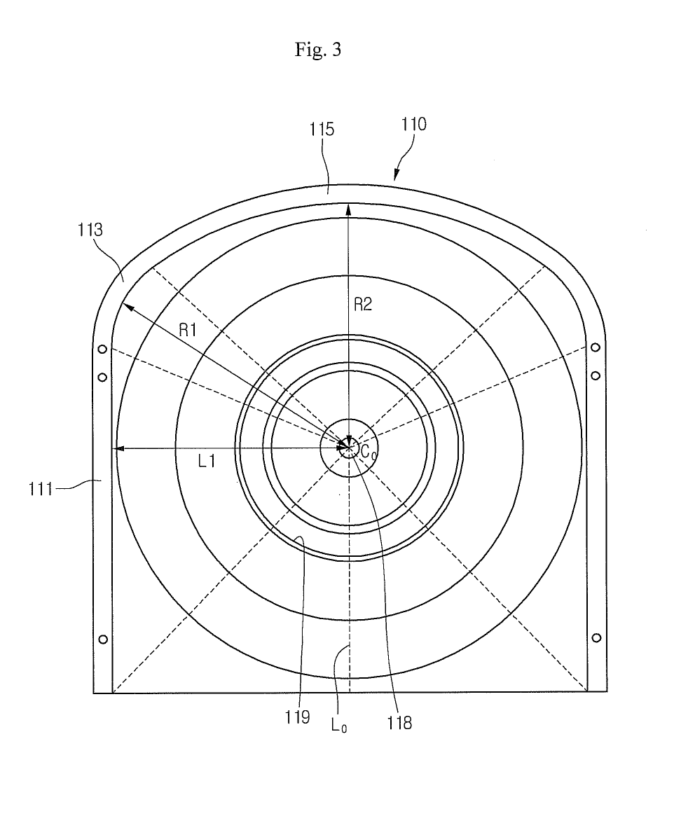

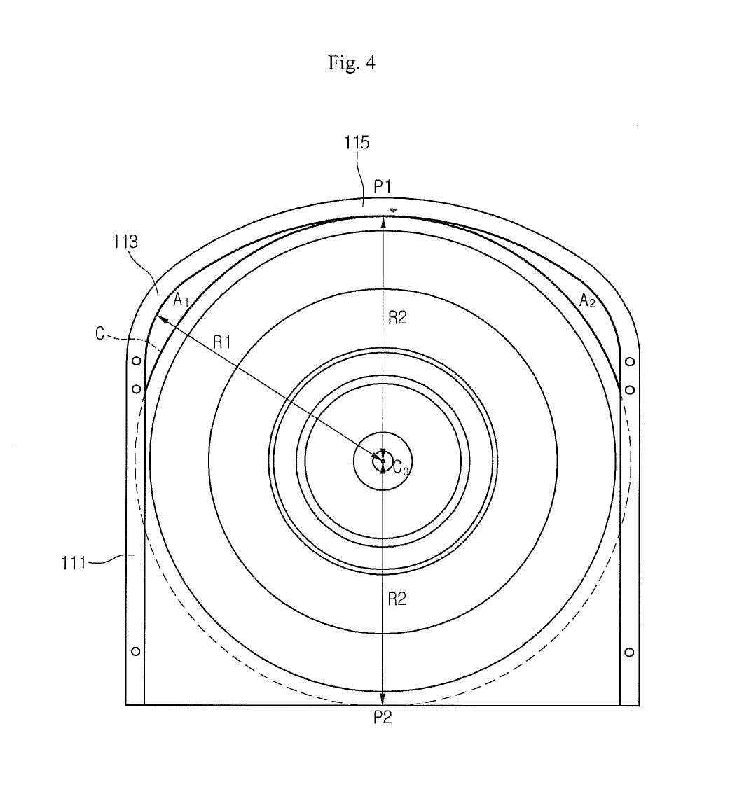

FIG. 2 is a view illustrating internal components of a cavity of the cooker of FIG. 1. FIGS. 3 and 4 are views illustrating a portion of the components of the cavity of the cooker of FIG. 1.

Referring to FIG. 2, the cavity 100 according to this embodiment may include a bottom part or portion 110, a side part or portion 130, and a rear part or portion 150, which define a cooking chamber S. An opening 105 may be defined in a front surface of the cavity 100. The front surface may be understood as one surface of the cavity 100 in a direction in which the door 25 is coupled to the other components of the cooker 100.

The bottom portion 110 may define a bottom surface of the cavity 100. Also, the bottom portion 110 may extend backward from the opening 105.

A rotation member 180 may be rotatably disposed on the bottom portion 110. A plate (not shown) may be mounted on a top surface of the rotation member 180. Food to be cooked may be placed on the plate.

A roller 182 that guides rotation of the rotation member 180 may be coupled to the rotation member 180. A plurality of roller(s) 182 may be provided.

The roller(s) 182 may move along an area of the bottom portion 110. A predetermined rotation path along which the roller(s) 182 may move in contact with the bottom portion 110 may be defined in at least a portion of the bottom portion 110.

A drive 185 to provide a driving force to the rotation member 180 may be disposed on or at an approximately central portion of the rotation member 180. The drive 185 may be coupled to an insertion portion 118 defined in an approximately central portion of the bottom portion 110. The insertion portion 118 may be a hole or groove so that the drive 185 or a shaft of the drive 185 may be inserted thereinto.

Also, in a state in which the rotation member 180 is coupled to an upper portion of the drive 185, at least one stepped portion 119 may be formed on the bottom portion 110 so that the roller(s) 182 may contact the bottom portion 110. The bottom portion 110 may have surfaces having heights different from each other due to the stepped portion 119.

The side portion 130 may extend upward from each of both sides of the bottom portion 110. Also, the rear portion 150 may extend from the side portion 130.

The side portion 130 and the rear portion 150 may have or form a plane portion and a curved portion, respectively. For example, the side portion 130 may form the plane portion, and the rear portion 150 may form the curved portion.

Referring to FIGS. 3 and 4, the bottom portion 110 on each side may include a plane portion 111, a first curved portion 113 that extends backward from the plane portion 111, which may be rounded with a first curvature, and a second curved portion 115 that extends backward from the first curved portion 113, which may be rounded with a second curvature. The bottom portion 110 may be disposed vertically symmetrical with respect to a center of a virtual line Lo that passes through a center Co of the insertion portion 118.

The plane portion 111 may be a portion corresponding to a lower end of the side portion 130, and the first and second curved portions may be portions corresponding to a lower end of the rear portion 150. In FIG. 3, the plane portion 111, the first curved portion 113, and the second curved portion 115 are distinguished from each other using dotted lines.

When a perpendicular line extends from the center Co of the insertion portion 118 with respect to the plane portion 111, the perpendicular line may have a length L1, as shown in FIG. 3. That is, the perpendicular line may extend perpendicularly with respect to the plane portion 111 from the center Co and have a length L1.

The first curved portion 113 and the second curved portion 115 may have a first radius of curvature R1 and a second radius of curvature R2 with respect to the center Co, respectively. That is, the first radius of curvature R1 may be a distance between the center Co of the insertion portion 118 and any point of or on the first curved portion 113, and the second radius of curvature R2 may be a distance between the center Co and any point of or on the second curved portion 115. The first radius of curvature R1 may be greater than the second radius of curvature R2, and the second radius of curvature R2 may be greater than the length L1 of the perpendicular line.

A virtual circle C, for which a distance between the center Co and point P1 of or on the second curved portion 115 is R2, is illustrated in FIG. 4. That is, the virtual circle C may be a circle having a radius R2 centered on the center Co. Point P2 is defined on the virtual circle C. The point P2 may be a point disposed on a side opposite to that of the point P1 with respect to the center Co.

As described above, the second radius of curvature R2 may be equal to or greater than the length L1. If the second radius of curvature R2 is equal to the length L1, the virtual circle C may contact the plane portion 111. On the other hand, if the second radius of curvature R2 is greater than the length L1, as shown in FIG. 4, the virtual circle C may be disposed to cross the plane portion 111.

Also, as described above, as the first radius of curvature R1 is greater than the second radius of curvature R2, the virtual circle C may pass through an inside of the first curved portion 113. That is, a predetermined area (hereinafter, referred to as an overlapping area) on which an outer area of the virtual circle C and an inner area of the first curved portion 113 overlap each other may be defined on the bottom portion 110. The overlapping area may include a first area A1 disposed on one side of the virtual line Lo and a second area A2 disposed on the other side of the virtual line Lo. The second area A2 may be disposed opposite to the first area A1 with respect to the virtual line Lo.

The first area A1 and the second area A2, due to the first curved portion 113, are greater compared to a case in which the second curved portion 115 extends so that the second curved portion 115 is directly connected to the plane portion 111. Thus, an inner space of the cooking chamber 100 may be sufficiently secured. Also, as the first and second curved portions 113 and 115 are provided, and thus, each of the bottom portion 110 and the cavity 110 are rounded, the corner portions of the cavity 110 may be easily cleaned to prevent the cavity from being contaminated.

Hereinafter, a description will be made of another embodiment. As the current embodiment is the same as the foregoing embodiment except for a portion of the components and a manufacturing method, differences between the embodiments will be described principally, and also descriptions of the same parts will be denoted by the same reference numerals and descriptions of the foregoing embodiment.

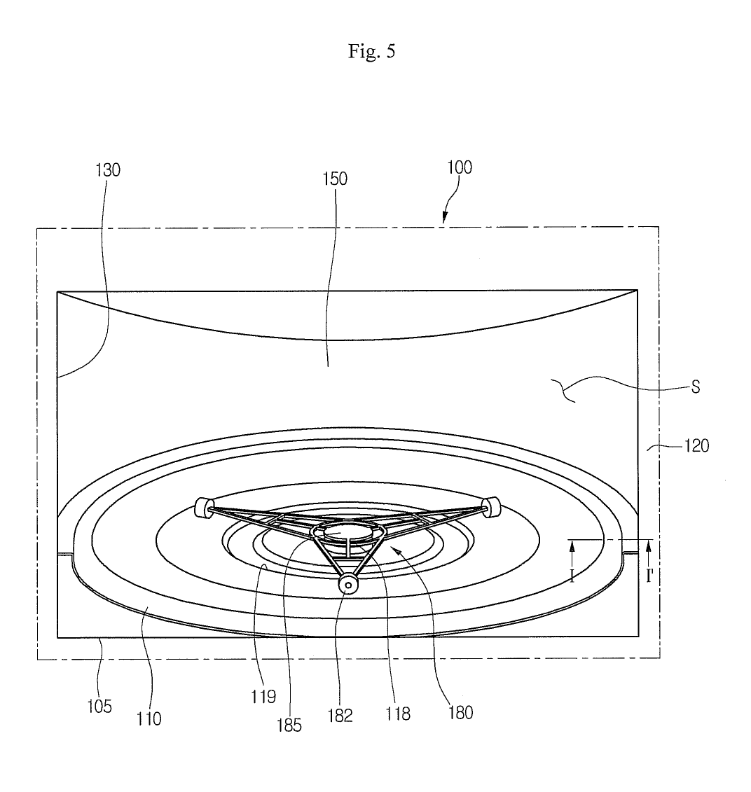

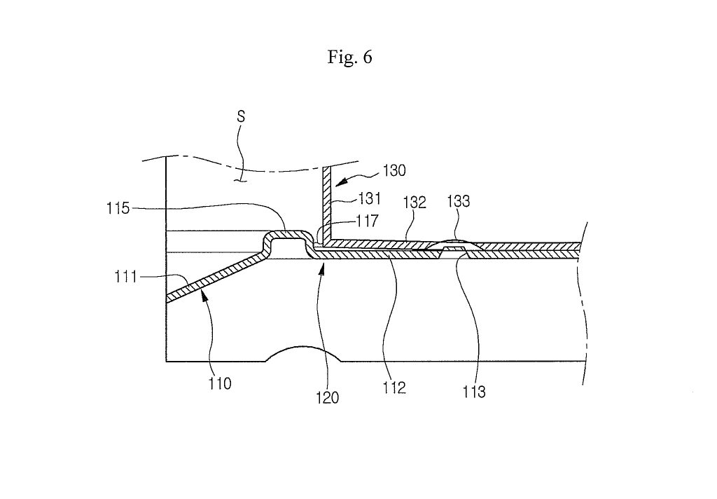

FIG. 5 is a view illustrating internal components of a cavity according to another embodiment. FIG. 6 is a cross-sectional view taken along line VI-VI′ of FIG. 5.

Referring to FIGS. 5 and 6, a cavity 100 defined in a cooking chamber S according to another embodiment may include a bottom portion 110 and a side portion 130 that extends upward from at least one side of the bottom portion 110.

The bottom part or portion 110 include a bottom portion body 111 that defines an outer appearance of a lower portion of the cavity 100 and a second outside extension portion 112 that extends outward from the bottom portion body 111. Here, the “outside” direction may represent an outward direction of the cooking chamber S.

The side portion 130 may include a side portion body 131 that defines an outer appearance of a side surface of the cavity 100 and a first outside extension portion 132 that extends outward from the side portion body 131. The side portion body 131 and the first outside extension portion 132 may be integrated with each other. The first outside extension portion 132 may be a portion bent from the side portion body 131 to extend outward.

The second outside extension portion 112 may be coupled to a lower portion of the first outside extension portion 132. A first coupling portion 113 coupled to the first outside extension portion 132 may be disposed on the second outside extension portion 112. Also, a second coupling portion 133 coupled to the first coupling portion 113 may be disposed on the first outside extension portion 132.

The first and second coupling portions 113 and 133 may be coupled or riveted by a predetermined coupling member. However, embodiments are not limited to the coupling method.

When the bottom portion 110 and the side portion 130 are coupled to each other, a space 120 may be generated or formed between the second outside extension portion 112 and the first outside extension portion 132. The space 120 may be a boundary area or gap between the bottom portion 110 and the side portion 130 which are in contact with each other. The space 120 may be provided where the side portion body 131 is bent to the first outside extension portion 132.

A protrusion 115 to cover the space 120 may be disposed at one side of the space 120, that is, inside of the space 120. The protrusion 115 may be disposed on or at an edge portion of the bottom portion body 111 and inside of the side portion body 131. The protrusion 115 may be coupled to a lower end of the side portion body 131. Here, “inside” of the side portion body 131 may represent a direction in which the cooking chamber S is defined with respect to the side portion body 131.

The protrusion 115 may be a portion at which at least one portion of the bottom portion body 111 protrudes upward. Also, the protrusion 115 may be formed by performing a forming process on the bottom portion body 111.

The protrusion 115 may have an upper end disposed at a predetermined height. The protrusion 115 may have a height greater than a height of the bottom portion body 111 and the second outside extension portion 112.

In more detail, the protrusion 115 may be disposed between the bottom portion body 111 and the second outside extension portion 112. Also, the protrusion 115 may protrude upward from the bottom portion body 111, and the second outside extension portion 112 may extend outward from a lower end of the protrusion 115. Thus, the protrusion 115 may have one surface that is coupled to the side portion body 131 and the bent portion of the first outside extension portion 132.

For example, the protrusion 115 may cover a left area or side of the space 120 when viewed in FIG. 6. As the protrusion 115 may be provided on or at the one side of the space 120, the space 120, that is, the coupled portion of the bottom portion 110 and the side portion 130 may not be exposed or seen (within the cooking chamber S).

A coupling area 117 may be defined on or at a portion at which the protrusion 115 and the space 120 are coupled to each other. The coupling area 117 may be formed by, for example, welding a portion at which the protrusion 115 contacts the side portion body 131 after the protrusion 115 is coupled to the bottom portion 110 and the side portion 130 to cover the space 120.

Also, after the coupling or welding process is performed, a painting process may be performed on the bottom portion 110 and the side portion 130 using paint having a predetermined color to performing a finishing process on the cooker. With this process, the liquid paint may be prevented from flowing into the space 120. That is, a flow of liquid paint toward the space 120 covered by the protrusion 115 may be restricted.

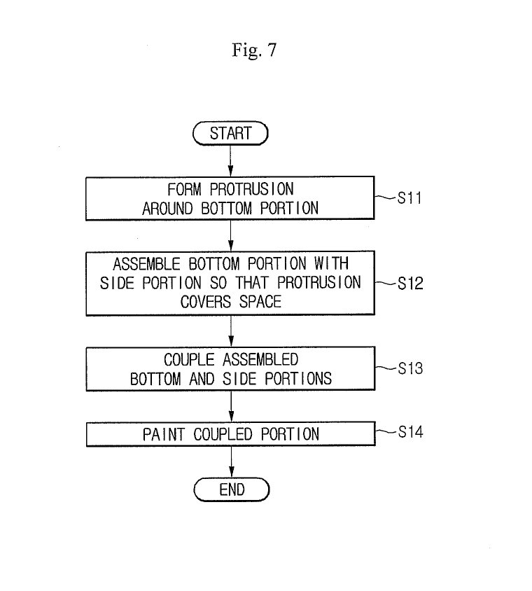

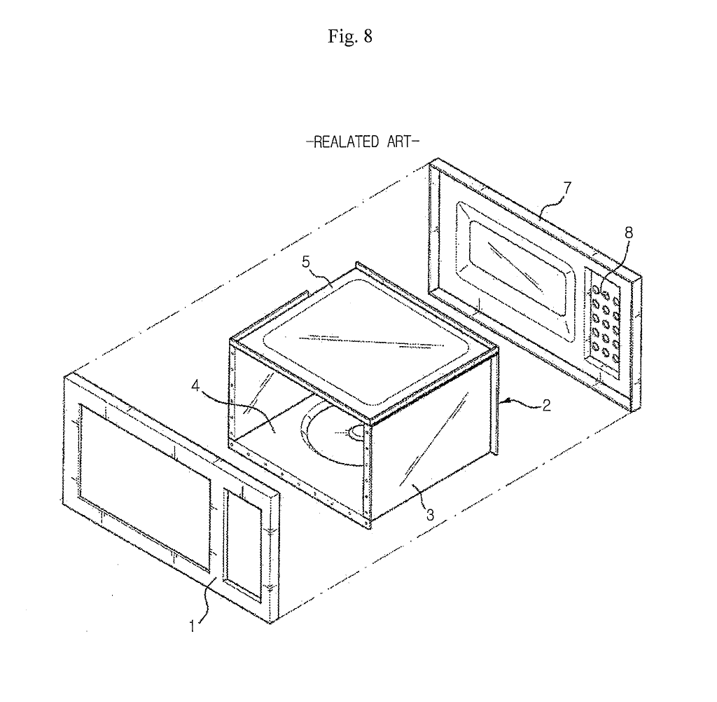

FIG. 7 is a flowchart of a method for manufacturing a cooker according to an embodiment. A method for manufacturing the cooker according to embodiments will be described with reference to FIG. 7.

According to embodiments, a process of preparing a bottom portion 110, a predetermined processing process may be performed on an edge portion of a bottom portion body 111 to form a protrusion 115, in step S11. Then, the bottom portion 110 and a side portion 130 may be assembled to allow the protrusion 115 to cover a space 120. That is, when the bottom portion 110 and the side portion 130 are assembled, an inner surface of a lower end of a side portion body 131 may be disposed outside of the protrusion 115, in step S12.

When the assembly of the bottom portion 110 and the side portion 130 is finished, the protrusion 115 may cover the space 120 between the bottom portion 110 and the side portion 130. Then, a coupling process, for example, a welding process, may be performed on the coupled portion of the protrusion 115 and the side portion body 131, in step S13. As the coupling process is performed, the bottom portion 110 and the side portion 130 may be firmly coupled to each other, in step S13.

As a finishing process in the manufacturing of the cavity 100, a painting process using a predetermined paint may be performed on inner surfaces of the bottom portion 110 and the side portion 130 in addition to the coupled portion. When the painting process is performed, the liquid paint may be blocked by the protrusion 115 to prevent the liquid paint from flowing into the space 120, in step S14.

According to embodiments, as a curved portion having a predetermined curvature may be provided on or at a rear portion of a cavity, or inside of a cooking chamber may be easily cleaned. Thus, the inside of the cooking chamber may be prevented from being contaminated. More particularly, as a plurality of curved portions having curvatures different from each other may be provided, volumetric losses occurring because of the curved portions may be reduced. Also, as angulated edge portions do not exist within the cooking chamber, food may be uniformly heated to effectively cook the food.

Also, as a protrusion may be provided on a bottom portion of the cavity to protrude to or in an extension direction of a side portion, a finishing process may be easily performed on a coupled portion of the bottom portion and the side portion. In particular, when the cavity is manufactured, a gap between the bottom portion and the side portion may be covered. Also, when a coupling or welding process is performed, a space between the protrusion and the side portion may be welded to realize an elegant outer appearance.

Embodiments disclosed herein provide a cooker having an improved cavity structure.

Embodiments disclosed herein provide a cooker that may include a cavity having a cooking chamber; an electrical chamber in which a part to provide heat to the cooking chamber may be disposed, the electrical chamber being defined in one side of the cavity; and a door disposed on a side of the cavity to selectively open or close the cooking chamber. The cavity may include a bottom part or portion that defines a bottom surface of the cavity; a side part that extends backward from each of both sides of the bottom part; and a rear part or portion rounded to extend backward from the side part.

The rear part may include a plurality of curved portions having curvatures different from each other. The plurality of curved portions may include a first curved portion rounded with a first curvature radius to extend from the side part, and a second curved portion that extends from the first curved portion, the second curved portion being rounded with a second curvature radius. The first curvature radius may be greater than the second curvature radius. The side part may be a plane portion.

The cooker may further included a rotation member rotatably disposed above the bottom part, and an insertion part or portion defined in the bottom part to provide a rotation center of the rotation member. The first curvature radius may be a distance between the insertion part and any point of or on the first curved portion, and the second curvature radius may be a distance between the insertion part and any point of or on the second curved portion.

A virtual circle may be defined with the second curvature radius with respect to the insertion part, and an outer area of the virtual circle and an inner area of the second curved portion may overlap by a preset area. The preset area may be defined on both sides with respect to a center line of the bottom part passing through the insertion part.

The bottom part may include a bottom part or portion body, and a protrusion that protrudes upward from an edge portion of the bottom part body, the protrusion being coupled to the side part. The side part may include a side part or portion body disposed outside the protrusion, and a first outside extension portion bent from the side part body to extend outward. The protrusion may have an upper end disposed at a height greater than that of a lower end of the side part body.

The bottom part may include a second outside extension portion extending outside from the bottom part body, the second outside extension portion being coupled to the first outside extension portion. A spaced portion may be defined between the first outside extension portion and the second outside extension portion, and the protrusion may cover the spaced portion.

Embodiments disclosed herein further provide a method for manufacturing a cooker having a cavity by assembling a bottom part or portion and a side part or portion that may include forming a protrusion that protrudes upward from an edge portion of the bottom part; disposing an inner surface of the side part outside the protrusion to assemble the side part with the protrusion; coupling or welding the assembled bottom and side parts; and painting the bottom part and the side part. In the assembling of the side part with the protrusion, an upper end of the protrusion may be disposed at a height greater than that of a lower end of the side part. The side part may includes a side part body and an outside extension portion bent from the side part body to extend outside, and the protrusion may be disposed on a side of the portion at which the outside extension portion is bent.

Embodiments disclosed herein further provide a cooker that may include a cavity having a cooking chamber; an electrical chamber in which a heater or a part to provide heat to the cooking chamber may be disposed, the electrical chamber being defined in one side of the cavity; and a door disposed on a side of the cavity to selectively open or close the cooking chamber. The cavity may include a bottom part that defines a bottom surface of the cavity; a side part that extends backward from each of both sides of the bottom part; a first curved portion rounded with a first curvature radius to extend backward from the side part; and a second curved portion extending from the first curved portion, the second curved portion having a second curvature radius greater than the first curvature radius.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cooker, comprising:
a cavity having a cooking chamber;
an electrical chamber in which a part to provide heat to the cooking chamber is disposed, the electrical chamber being defined at one side of the cavity; and
a door disposed on another side of the cavity to selectively open or close the cooking chamber, wherein the cavity comprises:
a bottom portion that defines a bottom surface of the cavity;
a side portion that extends from a side of the bottom portion to form a side surface of the cavity; and
a rear portion that extends from the side portion to form a rear surface of the cavity, the rear portion comprising at least one curved portion.

2. The cooker according to claim 1, wherein the at least one curved portion comprises a plurality of curved portions having curvatures different from each other.

3. The cooker according to claim 2, wherein the plurality of curved portions comprise:
a first curved portion having a first radius of curvature that extends from the side portion; and
a second curved portion that extends from the first curved portion, the second curved portion having a second radius of curvature.

4. The cooker according to claim 3, wherein the first radius of curvature is greater than the second radius of curvature.

5. The cooker according to claim 3, wherein the side portion is planar.

6. The cooker according to claim 3, further comprising:
a rotation member rotatably disposed on the bottom portion; and
an insertion portion defined in the bottom portion to provide a rotational center of the rotation member.

7. The cooker according to claim 6, wherein the first radius of curvature is a distance between a center of the insertion portion and any point on the first curved portion, and the second radius of curvature is a distance between the center of the insertion portion and any point on the second curved portion.

8. The cooker according to claim 6, wherein a virtual circle is defined by the second radius of curvature with respect to the insertion portion, and an outer area of the virtual circle and an inner area of the first curved portion overlap by a predetermined area.

9. The cooker according to claim 8, wherein the predetermined area is defined on both sides with respect to a center line of the bottom portion passing through the insertion portion.

10. The cooker according to claim 1, wherein the bottom portion comprises:
a bottom portion body; and
a protrusion that protrudes upward from an edge portion of the bottom portion body, the protrusion being coupled to the side portion.

11. The cooker according to claim 10, wherein the side portion comprises:
a side portion body disposed at an outside of the protrusion with respect to a center of the cooking chamber; and
a first outside extension portion bent from the side portion body to extend outward with respect to the center of the cooking chamber.

12. The cooker according to claim 11, wherein the protrusion has an upper end disposed at a height greater than a height of a lower end of the side portion body.

13. The cooker according to claim 12, wherein the bottom portion comprises:
a second outside extension portion that extends outward from the bottom portion body with respect to the center of the cooking chamber, the second outside extension portion being coupled to the first outside extension portion.

14. The cooker according to claim 13, wherein a space is defined between the first outside extension portion and the second outside extension portion, and wherein the protrusion covers the space.

15. A method for manufacturing a cooker having a cavity formed by assembling at least a bottom portion and a side portion to form the cavity, the method comprising:
forming a protrusion that protrudes upward from an edge portion of the bottom portion;
disposing an inner surface of the side portion outside of the protrusion with respect to a center of the cavity, to assemble the side portion with the protrusion of the bottom portion;
coupling the assembled bottom and side portions; and
painting the bottom portion and the side portion.

16. The method of claim 15, wherein the coupling the assembled bottom and side portion comprises welding the assembled bottom and side portions.

17. The method of claim 15, wherein the cavity comprises:
the bottom portion, which defines a bottom surface of the cavity;
the side portion that extends from a side of the bottom portion to form a side surface of the cavity when coupled thereto, and wherein the method further comprises:
coupling a rear portion to the assembled bottom portion and the side portion, wherein once coupled to the bottom portion and the side portion, the rear portion extends from the side portion, the rear portion comprising at least one curved portion.

18. The method according to claim 17, wherein the at least one curved portion comprises a plurality of curved portions having curvatures different from each other.

19. The method according to claim 18, wherein the plurality of curved portions comprise:
a first curved portion having a first radius of curvature that extends from the side portion; and
a second curved portion that extends from the first curved portion, the second curved portion having a second radius of curvature.

20. The method according to claim 19, wherein the first radius of curvature is a distance between a center of the cavity and any point on the first curved portion, and the second radius of curvature is a distance between the center of the cavity and any point on the second curved portion.

21. The cooker according to claim 20, wherein a virtual circle is defined by the second radius of curvature with respect to the center of the cavity, and an outer area of the virtual circle and an inner area of the first curved portion overlap by a predetermined area.

22. The cooker according to claim 15, wherein the bottom portion comprises a bottom portion body, and the protrusion; wherein the protrusion is coupled to the side portion; wherein the side portion comprises a side portion body disposed at an outside of the protrusion with respect to a center of the cooking chamber, and a first outside extension portion bent from the side portion body to extend outward with respect to a center of the cooking chamber; wherein the protrusion has an upper end disposed at a height greater than a height of a lower end of the side portion body; wherein a space is defined between the first outside extension portion and the second outside extension portion; and wherein the protrusion covers the space.

23. The method according to claim 22, wherein the bottom portion comprises:
a second outside extension portion that extends outward from the bottom portion body with respect to the center of the cavity, the second outside extension portion being coupled to the first outside extension portion.

24. A cooker manufactured according to the method of claim 15.

25. A cooker, comprising:
a cavity having a cooking chamber;
an electrical chamber in which a part to provide heat to the cooking chamber is disposed, the electrical chamber being defined in one side of the cavity; and
a door disposed on another side of the cavity to selectively open or close the cooking chamber, wherein the cavity comprises:
a bottom portion that defines a bottom surface of the cavity;
a side portion that extends from a side of the bottom portion;
a first curved portion having a first radius of curvature that extends backward from the side portion; and
a second curved portion that extends from the first curved portion, the second curved portion having a second radius of curvature greater than the first radius of curvature.

26. The cooker according to claim 25, further comprising:
a rotation member rotatably disposed on the bottom portion; and
an insertion portion defined in the bottom portion to provide a rotational center of the rotation member, wherein the first radius of curvature is a distance between the insertion portion and any point on the first curved portion, and the second radius of curvature is a distance between the insertion portion and any point on the second curved portion.

27. The cooker according to claim 25, wherein the bottom portion comprises:
a bottom portion body;
a second outside extension portion that extends from the bottom portion body to an outside of the cooking chamber; and
a protrusion that protrudes upward from a bottom surface of the bottom portion and coupled to the side portion, the protrusion being disposed between the bottom portion body and the second outside extension portion.

28. The cooker according to claim 27, wherein the side portion comprises:
a side portion body disposed outside the protrusion with respect to a center of the cooking chamber; and
a first outside extension portion bent from the side portion body to extend outward with respect to the center of the cooking chamber, the first outside extension portion forming a space together with the second outside extension portion, wherein the protrusion covers the space.

29. The cooker according to claim 27, wherein the protrusion is disposed at a height greater than a height of the bottom portion body and the second outside extension portion.
